(19) United States
(12) Patent Application Publication
(10) Pub. No.: US 2025/0095619 A1
(43) Pub. Date: Mar. 20, 2025

(54) CONTROL METHOD, CONTROL DEVICE AND MUSICAL INSTRUMENT

(71) Applicant: YAMAHA CORPORATION, Hamamatsu-shi (JP)

(72) Inventor: Hidenari KIM, Hamamatsu-shi (JP)

(21) Appl. No.: 18/887,202

(22) Filed: Sep. 17, 2024

(30) Foreign Application Priority Data
Sep. 20, 2023 (JP) 2023-152495

(51) Int. Cl. G10H 3/18

(52) U.S. Cl. CPC G10H 3/18; G10H 2210/076

(57) ABSTRACT

A control method for a musical instrument, the method comprising calculating a play speed of the musical instrument based on performance information corresponding to a performance operation of the musical instrument, receiving beat count information for identifying a number of beats, and generating control information for controlling a timing of executing a process associated with a loop based on the beat count information and the play speed is provided. A preset process can be automatically executed at a timing according to an instruction input by a user.

### CROSS-REFERENCE TO RELATED APPLICATIONS

This application claims the benefit of priority to Japanese Patent Application No. 2023-152495, filed on Sep. 20, 2023, the entire contents of which are incorporated herein by reference.

### FIELD

The present disclosure relates to a technique for controlling sound.

### BACKGROUND

In musical instruments, various contrivances have been made for the generation of sounds. For example, International patent publication No. WO 2018/201100 discloses a guitar provided with various operators for adding various sound effects to the generated sound.

### SUMMARY

According to an embodiment of the present disclosure, there is provided a control method for a musical instrument, the method including calculating a play speed of the musical instrument based on performance information corresponding to a performance operation of the musical instrument, receiving beat count information for identifying a number of beats, and generating control information for controlling a timing of executing a process associated with a loop based on the beat count information and the play speed.

According to an embodiment of the present disclosure, there is provided a control device for a musical instrument, the control device including a memory storing a program, and a processor that executes the program to calculate a play speed of the musical instrument based on performance information corresponding to a performance operation of the musical instrument, receive beat count information for identifying a number of beats, and generate control information for controlling a timing of executing a process associated with a loop based on the beat count information and the play speed.

According to an embodiment of the present disclosure, there is provided a musical instrument including the control device and an operator for receiving the performance operation.

According to an embodiment of the present disclosure, there is provided a musical instrument including a string, a soundboard that transmits vibration of the string, a detector attached to the soundboard to detect an input of an instruction of a user, and a processor configured to execute a predetermined process at a timing determined based on a timing at which the instruction is received and a set delay time.

### BRIEF DESCRIPTION OF DRAWINGS

FIG. 1 is a front view showing an acoustic guitar according to an embodiment.

FIG. 2 is a side view of the guitar shown in FIG. 1.

FIG. 3 is a plan view of an inner surface of a back board of a body of the guitar shown in FIG. 1 as viewed from a direction perpendicular to the inner surface.

FIG. 4 is a block diagram showing an example of a configuration of a control device according to an embodiment.

FIG. 5 is a block diagram showing an example of a functional configuration of a control part according to an embodiment.

FIG. 6 is a conceptual diagram for explaining a timing for executing a process associated with a loop.

FIG. 7 is a conceptual diagram for explaining a timing for executing a process associated with a loop.

FIG. 8 is a flowchart showing an example of a flow of a process associated with a loop executed by a control part.

### DESCRIPTION OF EMBODIMENTS

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same reference signs or similar reference signs (only denoted by A, B, or the like after the numerals), and repetitive description thereof may be omitted. In the drawings, dimensional ratios may be different from actual ratios, or a part of the configuration may be omitted from the drawings for clarity of explanation.

According to the present disclosure, it is possible to control such that a preset process is automatically executed at a timing corresponding to an instruction input by a user.

### [Composition of Music Instrument]

A musical instrument according to an embodiment of the present disclosure is capable of attaching a vibration exciter having a predetermined weight to an acoustic member. Hereinafter, a musical instrument according to an embodiment will be described. In the embodiment described below, a case where the musical instrument is an acoustic guitar will be described as an example. In addition, the musical instrument according to the present disclosure is not limited to an acoustic guitar.

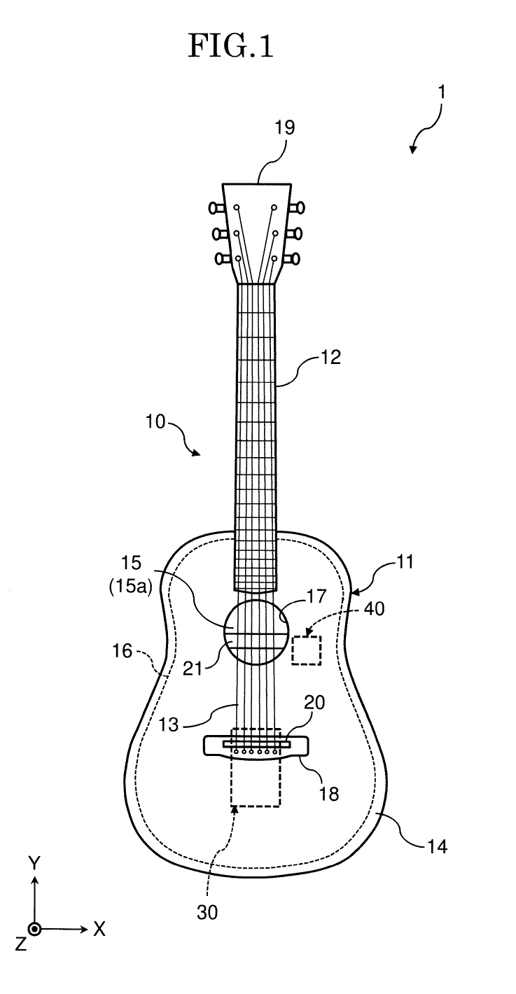

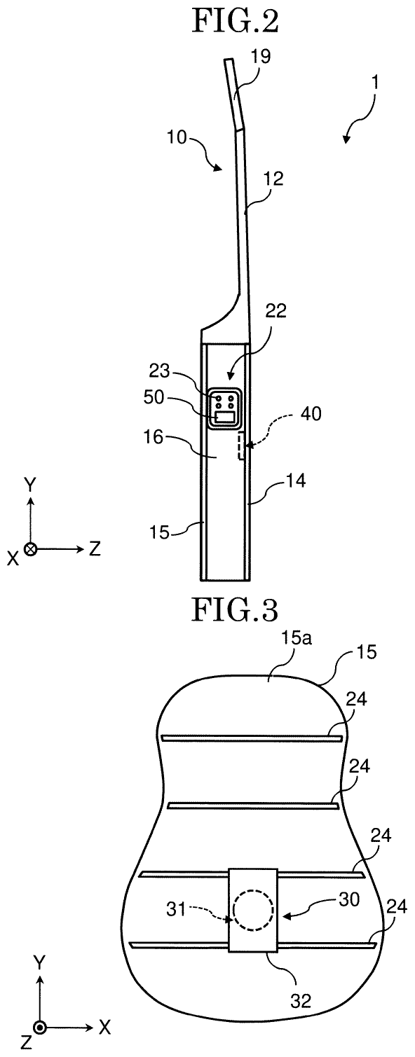

A musical instrument according to an embodiment of the present disclosure will be described with reference to FIG. 1 to FIG. 3. FIG. 1 is a front view showing an acoustic guitar according to an embodiment. FIG. 2 is a side view of the guitar shown in FIG. 1. FIG. 3 is a plan view of an inner surface of a back board of a body of the guitar shown in FIG. 1 as viewed from a direction perpendicular to the inner surface.

As shown in FIG. 1, an acoustic guitar 1 (hereinafter referred to as guitar 1) includes a guitar body 10 (musical instrument body) and a vibration exciter 30. The guitar body 10 includes a body 11, a neck 12, a string 13, a pickup 21, a control unit 22, and a detection sensor (detector) 40.

The body 11 is formed in a box shape having a cavity therein. The body 11 includes a top board 14, a back board 15, and sides 16. The top board 14 and the back board 15 are flat boards having the same shape. The top board 14 and the back board 15 are spaced apart from each other in a board thickness direction. The sides 16 extend from a peripheral edge of the back board 15 to a peripheral edge of the top board 14. The top board 14, the back board 15, and the sides 16 constitute a soundboard. The top board 14, the back board 15, and the sides 16 constitute the body 11 having the cavity therein. In the following description, a direction in which the top board 14 and the back board 15 are arranged (Z-axis direction) may be referred to as a vertical direction.

In the top board 14, a sound hole 17 penetrating is formed in a board thickness direction. The sound hole 17 connects the cavity of the body 11 to space outside the body 11. An outer surface of the top board 14 is provided with a bridge 18 for fastening a first end of the string 13 in a longitudinal direction.

The control unit 22 is arranged on the sides 16. The control unit 22 includes an operation unit 23 and a control device 50. The operation unit 23 includes one or more setting operators for controlling settings of the guitar 1 and a sound output from the guitar 1. The setting operators include an operation button, a touch sensor, a slider, and the like. The operation unit 23 generates an operation signal in response to an operation by a user, and outputs the operation signal to the control device 50 to be described later. The operation signal includes beat count information for identifying the number of beats of a music piece. The beat count information will be described later. Here, although the control unit 22 is arranged on the sides 16, the position where the control unit 22 is arranged is not limited to the sides 16. The control device 50 will be described later.

The neck 12 extends from the body 11 in a direction substantially orthogonal to the vertical direction (Z-axis direction). At a tip of the neck 12, a head 19 for winding up a second end side of the string 13 in the longitudinal direction is provided. In the following description, a direction orthogonal to the vertical direction and in which the neck 12 mainly extends (Y-axis direction) may be referred to as a front-rear direction. Further, a direction orthogonal to the vertical direction and the front-rear direction may be referred to as a left-right direction (X-axis direction).

The string (operator) 13 is stretched over the body 11 and the neck 12 in the front-rear direction. Specifically, the first end of the string 13 is fastened to the bridge 18 of the body 11, and the second end of the string 13 is wound at the head 19. Thus, the string 13 is stretched between the bridge 18 and the head 19. The string 13 vibrates according to a performance of the user.

A saddle 20 is provided between the string 13 and the outer surface of the top board 14. In the guitar 1, vibration of the string 13 is transmitted to the top board 14 via the saddle 20, so that the top board 14 vibrates, and the back board 15 and the sides 16 also vibrate. As a result, air in the body 11 (cavity) resonates, and a sound is radiated to the outside of the body 11.

The pickup 21 detects the vibration of the string 13 and outputs a performance signal (performance information) corresponding to the vibration of the string 13. In FIG. 1, the pickup 21 is arranged at a position where the sound hole 17 of the top board 14 is formed so as not to hinder the vibration of the top board 14 caused by the vibration of the string 13. However, the position at which the pickup 21 is installed is not limited thereto. The performance signal output from the pickup 21 is supplied to the control device 50. The performance signal may be audio data (waveform data) or sound generation control data such as MIDI data.

In addition, the guitar 1 may include a communication unit (not shown). The guitar 1 can transmit and receive signals to and from an external device via the communication unit. In the case where the control device 50 is outside the guitar 1, the performance signal is transmitted to the control device 50 via the communication unit.

The detection sensor 40 is mounted inside the top board 14. The detection sensor 40 outputs a detection signal corresponding to a force applied to the body 11. The detection sensor 40 may be, for example, a deflection detection sensor (for example, a strain gauge) that detects a deflection caused in the body 11 by a force applied to the body 11. Further, the detection sensor 40 may be, for example, a pressure sensor that detects a pressure applied to the body 11. In addition, the detection sensor 40 may be, for example, an electrostatic contact sensor detecting that the user touches the body 11.

Here, although the detection sensor 40 is attached to the inside of the top board 14, the position where the detection sensor 40 is attached is not limited to the top board 14, and can be attached to any position of the body 11. For example, the detection sensor 40 is preferably arranged at a position where a finger of the user easily approaches when the user plays the guitar 1. The detection sensor 40 detects contact of the finger or the hand of the user with the body 11. The user may perform a predetermined action before or during the performance of the guitar 1, such as by tapping the body 11 to take a count. The detection sensor 40 can detect the predetermined action.

The back board 15 of the body 11 has an inner surface 15a facing the top board 14 in the vertical direction. As shown in FIG. 3, a plurality of ribs 24 is attached to the inner surface 15a of the back board 15. Each of the ribs 24 is fixed at a predetermined position by bonding or the like to the inner surface 15a. Shapes, number, positions, and the like of the ribs 24 shown in FIG. 3 are examples, and the positions and the like may be changed as appropriate depending on a purpose of increasing rigidity of the back board 15, a purpose of adjusting a tone color of the guitar 1, and the like.

The vibration exciter 30 includes a vibration exciter main body 31 (hereinafter referred to as a main body 31) and a support unit 32. The main body 31 vibrates the back board 15 (soundboard) of the body 11 described above. The main body 31 is connected to the control device 50. The main body 31 may be connected to the control device 50 by wire, or may be wirelessly connected to the control device 50 so that a wireless unit (not shown) arranged in the main body 31 receives a signal from the control device 50. The support unit 32 supports the main body 31 and fixes it to the inner surface 15a of the back board 15. The main body 31 may be, for example, a voice coil type actuator.

The control device 50 outputs a sound signal in accordance with a control signal (control information) generated based on a performance signal indicating musical piece data or sound/voice data stored in advance, or the vibration of the sound generation source (that is, string 13) of the guitar 1. The main body 31 of the vibration exciter 30 vibrates the back board 15 in accordance with a drive signal (electric signal) based on the sound signal. In addition, although an example of vibrating the back board 15 in the present embodiment, the place to vibrate is not limited to the back board 15. For example, the main body 31 of the vibration excitor 30 may vibrate the top board 14 or both the back board 15 and the top board 14. Alternatively, the main body 31 of the vibration excitor 30 may vibrate the sides 16 and may vibrate the sides 16, the top board 14, and/or the back board 15.

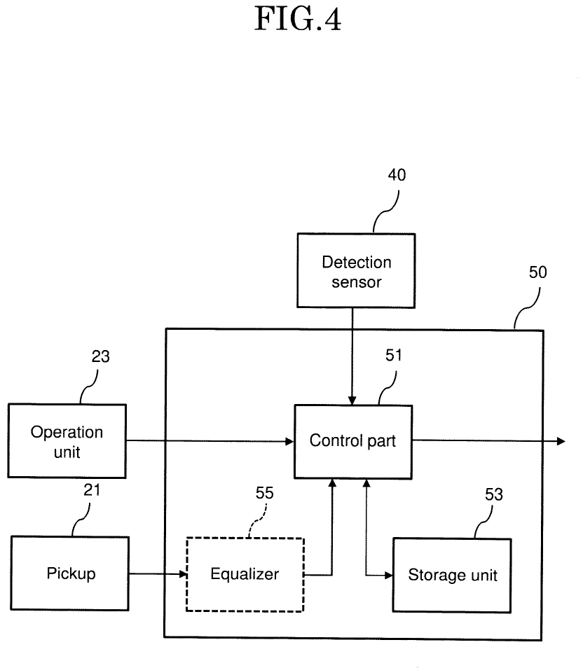

FIG. 4 is a block diagram showing an example of a configuration of the control device 50. The control device 50 includes a control part 51 and a storage unit 53. The control device 50 may also include an equalizer 55. Here, the control device 50 is attached to the body 11 of the guitar 1 as the control unit 22. However, the control device 50 may be an external device capable of communicating with the guitar 1. In this case, the control device 50 includes a communication unit (not shown) capable of communicating with an external device such as the guitar 1. The control device 50 is connected to the main body 31 of the vibration excitor 30 by wire or wirelessly.

The performance signal (performance information) output from the pickup 21, the operation signal output from the operation unit 23, and the detection signal output from the detection sensor 40 are supplied to the control part 51. In the case where the control device 50 includes the equalizer 55, the performance signal output from the pickup 21 is supplied to the control part 51 after a frequency characteristic is adjusted by the equalizer 55. In the case where the control device 50 does not include the equalizer 55, the performance signal is directly supplied to the control part 51.

The control part 51 includes an arithmetic processing circuit such as a CPU and a storage device such as a RAM or a ROM. The control part 51 implements various functions by executing a control program stored in the storage unit 53 by the CPU. The storage unit 53 is a storage device such as a nonvolatile memory. The storage unit 53 stores a control program executed by the control part 51. Further, the storage unit 53 stores information necessary for the control part 51 to execute processing. The control part 51 implements various functions by executing the control program. In the present embodiment, the control part 51 implements a loop function. Hereinafter, a process for realizing the loop function will be referred to as a process associated with the loop. The process associated with the loop includes recording a sound signal based on the performance sound (recording processing) by switching between start and end of recording of the performance sound corresponding to the performance operation, and repeatedly reproducing the recorded sound signal (loop reproduction processing).

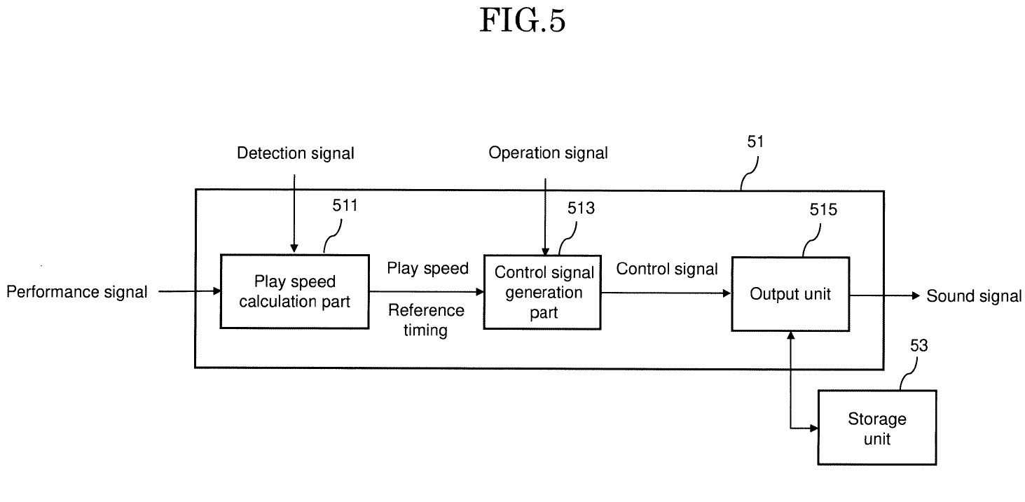

FIG. 5 is a block diagram showing an example of a functional configuration of the control part 51. The control part 51 includes a play speed calculation part 511, a control signal generation part 513, and an output part 515. The control part 51 generates a control signal (control information) based on the operation signal and the performance signal.

The play speed calculation part 511 obtains a performance signal (performance information). Further, when the detection signal is output from the detection sensor 40, the play speed calculation unit 511 obtains the detection signal from the detection sensor 40. As described above, the detection sensor 40 can detect a predetermined action before or during a performance by the user by detecting a contact of the finger or the hand of the user with the body 11. That is, the detection signal is an instruction indicating start of counting by the user. When the detection signal is input, the play speed calculation part 511 determines a reference timing that serves as a reference for starting counting a beat of the performance based on the detection signal. The reference timing is, for example, a timing at which the predetermined action by the user before or during performance is detected. Further, the reference timing is, for example, a timing at which a performance signal is output immediately after the predetermined action by the user before a performance is detected. The play speed calculation part 511 calculates a play speed (a tempo of the performance) based on the obtained performance signal. Specifically, the play speed calculation part 511 calculates the play speed (the tempo of the performance) based on the performance signal output in a predetermined period of a performance period in which the user is playing the guitar 1. This “predetermined period” is any period of time before and after the reference timing and a period including the reference timing, and may be a preset period before a desired process is started. The “predetermined period” may be set by the user. The play speed (the tempo of the performance) is obtained by calculating BPM of the performance. The play speed calculation part 511 outputs information indicating the reference timing and the calculated play speed to the control signal generation part 513.

The control signal generation part 513 receives information indicating the reference timing and the play speed from the play speed calculation part 511. Further, the control signal generation part 513 obtains an operation signal. The operation signal includes beat count information and information specifying the desired process associated with the loop. The beat count information is, for example, beat information for identifying how many beats later the process associated with the loop is executed. The beat count information is preset by the user via the operation unit 23.

The control signal generation part 513 generates a control signal (control information) for controlling a timing of executing the process associated with the loop, based on the beat count information and the play speed (tempo of the performance). Execution of the process associated with the loop includes at least one of starting the process associated with the loop and ending the process associated with the loop. That is, the timing for executing the process associated with the loop includes at least one of a timing for starting the process associated with the loop and a timing for ending the process associated with the loop. As described above, the process associated with the loop includes the recording processing and the loop reproduction processing. The user can set the desired process associated with the loop via the operation unit 23.

The control signal generation part 513 determines a time (period) until the execution of the process associated with the loop based on the beat count information and the play speed (tempo of the performance). Further, the control signal generation part 513 determines a timing at which the process associated with the loop is executed based on the reference timing and a time (period) until the process associated with the loop is executed.

For example, in the case where the user designates that the loop reproduction processing is to be executed 24 beats after the start of the performance, the user sets “24 beats” as the beat count information via the operation unit 23, and sets the loop reproduction processing as a desired process associated with the loop. As described above, the play speed calculation part 511 determines the reference timing based on the detection signal, and further calculates the play speed (the tempo of the performance) based on the performance signal. Further, the control signal generation part 513 generates a control signal for starting the loop reproduction processing after 24 beats from the reference timing, based on the operation signal and the play speed obtained from the play speed calculation part 511. Here, the timing at which the loop reproduction processing is started is a timing after 24 beats depending on the play speed from the reference timing. That is, the timing 24 beats after the reference timing is variable according to the play speed.

In the case where the process associated with the loop desired by the user is the loop reproduction processing, the control signal generation part 513 outputs the control signal to the output part 515. The output part 515 obtains a sound signal for reproduction stored in advance, and outputs the sound signal to a driving device (not shown) for driving the vibration exciter 30 at a timing based on the control signal. In the present embodiment, the sound signal for reproduction is stored in advance in the storage unit 53 of the control device 50. The output part 515 reads a sound signal for reproduction from the storage unit 53. In addition, the sound signal for reproduction may be stored in an external storage device capable of wired or wireless communication with the control device 50. In this case, the output part 515 reads the sound signal for reproduction from the external storage device by wired communication or wireless communication.

The driving device for driving the vibration exciter 30 may be included in the control device 50, or may be a separate device capable of wired or wireless communication with the control device 50. The driving device generates a drive signal for driving the vibration excitor 30 based on the sound signal for reproduction, and outputs the generated drive signal to the main body 31 of the vibration excitor 30. The main body 31 vibrates the back board 15 in accordance with the drive signal. Thus, in the guitar 1, the loop reproduction processing is executed at a timing based on the control signal. In addition, FIG. 5 is a functional block diagram, and arrows connecting the play speed calculation part 511, the control signal generation part 513, and the output part 515, respectively, indicate flows of signals, and do not indicate orders of processing. That is, for example, these three functions executed by a program or the like may be processed in any order.

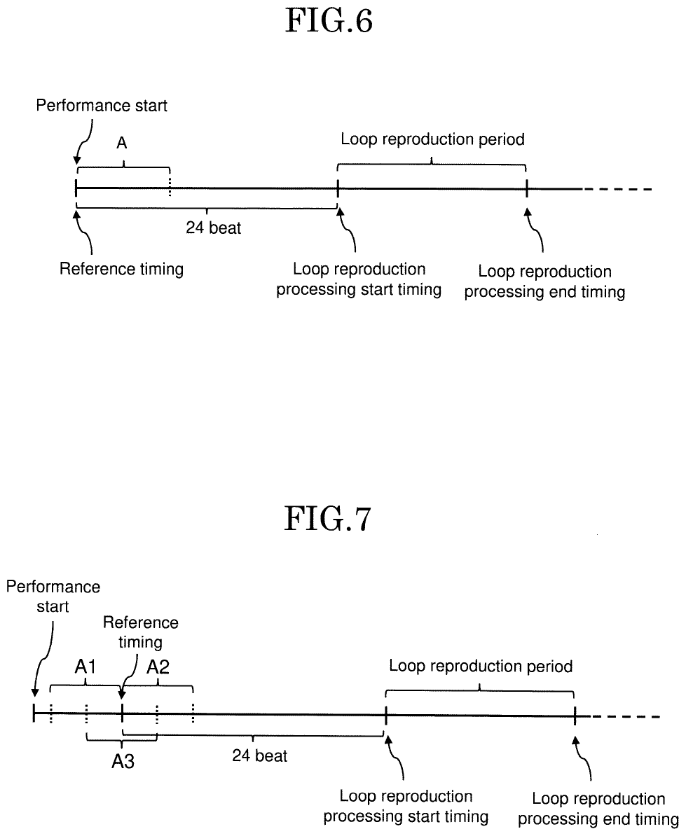

FIG. 6 and FIG. 7 are conceptual diagrams for explaining timings for executing the process associated with the loop. Here, as an example, a case will be described in which the process associated with the loop is the loop reproduction processing and the beat count information is “24 beats”.

FIG. 6 shows a case where the reference timing based on the detection signal is the same as the performance start (timing at which the performance signal is output). In this case, the play speed calculation part 511 calculates a play speed based on a performance signal output in a period A after the start of the performance. The control signal generation part 513 determines the timing after 24 beats from the reference timing based on the play speed calculated by the play speed calculation part 511 as a loop reproduction processing start timing. The control signal generation part 513 generates a control signal for starting the loop reproduction processing after 24 beats from the reference timing. The output part 515 reads the sound signal for reproduction from the storage unit 53 based on the control signal, and outputs the sound signal to the driving device. When the reading of the sound signal for reproduction by the output part 515 is completed, the loop reproduction processing ends. That is, a loop reproduction processing end timing is a timing at which the output part 515 has finished reading the sound signal for reproduction. A loop reproduction period is a period from the loop reproduction processing start timing to the loop reproduction processing end timing. In addition, in FIG. 6, the period A indicates a period immediately after the start of the performance. However, the period A may be a period after a predetermined time has elapsed from the start of the performance.

FIG. 7 shows a case where the reference timing based on the detection signal is after the start of the performance (the timing at which the performance signal is output). In this case, the play speed calculation part 511 calculates the play speed based on the performance signal output in any of the periods A1, A2, and A3 after the performance is started. The period A1 is a predetermined period before the reference timing. The period A2 is a predetermined period after the reference timing. The period A3 is a predetermined period before and after the reference timing, including the reference timing. The user can set any one of the periods A1 to the period A3 via the operation unit 23. Generation of the control signal by the control signal generation part 513 and reading and output of the sound signal for reproduction based on the control signal by the output part 515 are the same as those described with reference to FIG. 6.

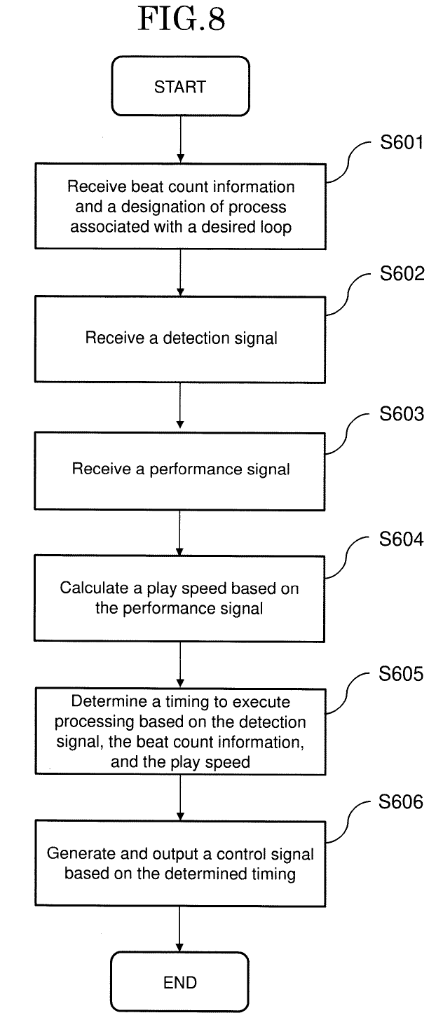

FIG. 8 is a flowchart showing an example of the process flow associated with the loop executed by the control part 51.

Prior to the performance, the control part 51 receives the beat count information and designation of the process associated with the loop desired by the user (S601). Next, the control part 51 receives a detection signal (S602). The control part 51 determines a reference timing based on the detection signal. When the user starts playing, the control part 51 receives a performance signal (S603). The play speed calculation part 511 of the control part 51 calculates a play speed (a tempo of the performance) based on the performance signal (S604).

The control signal generation part 513 of the control part 51 determines a timing at which a process associated with a loop desired by the user is executed based on a detection signal, beat count information, and the play speed (S605). Next, the control signal generation part 513 generates and outputs the control signal based on the determined timing (S606).

In the case where a predetermined action of the user is detected during the performance operation, in other words, in the case where a predetermined action performed by the user during the performance is detected by the detection sensor 40 after the user starts the performance of the guitar 1, the process of S602 and the process of S603 described above may be reversed in order.

As described above, when the user has previously set the beat count information and the process associated with the desired loop before the performance, the control part 51 determines the timing for executing the process associated with the desired loop based on the set beat count information. Therefore, the user can omit an operation for executing a desired process associated with the loop during the performance. Further, the control part 51 calculates the play speed of the user, and determines the time from the reference timing to a timing at which the desired process associated with the loop is executed, based on the calculated play speed and the beat count information. Therefore, even if the play speed is any speed, the control part 51 can automatically determine the timing at which the desired process associated with the loop is executed based on the beat count information and the play speed.

Hereinafter, modifications of the embodiment described above will be described.

### [Modification 1]

In the embodiment described above, a reference timing for determining a timing for executing a process associated with a loop is determined based on a detection signal that detects a predetermined action performed by a user before or during a performance. However, in the case where the user does not perform a predetermined action before or during the performance, the detection signal is not output. In this case, a timing at which the performance is started may be determined as the reference timing, or the user may set the reference timing via the operation unit 23.

In addition, the signal for determining the reference timing is not limited to the detection signal output from the detection sensor 40. For example, the user may output a signal indicating the start of performance to the control device 50 via the operation unit 23 instead of performing a predetermined action on the body 11 before the start of performance. Further, the signal indicating the start of performance may be output to the control device 50 by operating a predetermined switch provided in the guitar 1. The control part 51 can determine the reference timing based on the signal indicating the start of performance.

### [Modification 2]

The process associated with the loop includes the recording processing in addition to the loop reproduction processing described above. The recording processing includes a recording start process and a recording end process. In the case of starting the recording, the user designates the recording start process via the operation unit 23 and sets the beat count information. The control part 51 determines a timing at which the recording start process is executed based on the reference timing, the set beat count information, and the performance signal, and generates a control signal for executing the recording start process at the determined timing.

The control part 51 executes the recording start process based on the generated control signal. When recording is started based on the control signal, the control part 51 causes the storage unit 53 to store the performance signal output from the pickup 21. The performance signal output from the pickup 21 may be stored in the storage unit 53 after frequency characteristics are adjusted by the equalizer 55.

In the case of a recording end process is executes, the user designates the recording end process via the operation unit 23 and sets the beat count information. The control part 51 determines a timing at which the recording end process is executed based on the reference timing, the set beat count information, and the performance signal, and generates a control signal for executing the recording end process at the determined timing. The control part 51 ends the continuous recording process based on the control signal.

In the case of performing the recording processing, a combination of recording start and recording end may be set. That is, the user can set both the beat count information specifying the timing at which the recording start process is executed and the beat count information specifying the timing at which the recording end process is executed. In this case, the control part 51 executes the recording start process based on the reference timing, the set beat count information, and the play speed, and executes the recording end process based on the set beat count information and the play speed. Here, the timing at which the recording end process is executed is determined based on the set beat count information, the play speed, and the timing at which the recording start process is executed. The performance signal stored in the storage unit 53 can be used as a sound signal for reproduction used in the loop reproduction process.

Further, in the case of the recording processing, the control part 51 may generate a control signal for controlling the performance signal stored in the storage unit 53 on the basis of the reference timing, the set beat count information, and the performance signal. In this case, all the performance signals output from the start of the performance until the end of the performance are temporarily stored in the storage unit 53. The control part 51 determines a recording start processing timing and a recording end processing timing based on the reference timing, the set beat count information, and the performance signal, and determines a period from the recording start processing timing to the recording end processing timing as a recording period. The control part 51 generates a control signal indicating the recording period, and causes the performance signals stored in the storage unit 53, other than those output during the recording period, to be deleted from the storage unit 53 based on the control signal. That is, the performance signal finally stored in the storage unit 53 is only the performance signal output during the recording period.

### [Modification 3]

In the embodiment described above, the beat count information is beat information for identifying how many beats later the process associated with the loop is executed. However, the beat count information is not limited to the beat information. For example, the beat count information may be information indicating a desired number of bars for identifying after which bars the process associated with the loop is performed.

### [Modification 4]

In the embodiment described above and the modifications described above, the control part 51 determines a time (period) from the reference timing to the execution of the process associated with the loop based on the beat count information and the play speed, and determines a timing at which the processing is executed. However, the time (period) from the reference timing until the process associated with the loop is executed may be set by the user.

For example, the user may set a delay time via the operation unit 23. The delay time is a delay time from the reference timing, and is a time (period) from the reference timing until the process associated with the loop is executed. The delay time may be a fixed value or a variable value. The user can omit the operation for executing the process associated with the loop during the performance as in the embodiment described above by setting the delay time in advance before the performance.

### [Modification 6]

In the embodiment and the modifications described above, the control part 51 realizes the loop function by executing the control program stored in the storage unit 53. However, the function realized by the control part 51 executing the control program is not limited to the loop function.

For example, the control part 51 may add predetermined sound processing to the performance of the guitar 1 by the user. The sound processing includes, for example, a process of imparting distortion, a process of imparting reverb, a process of imparting a flanger, a process of changing a frequency band, and the like. The user can designate a desired sound processing via the operation unit 23.

The control part 51 generates a control signal for controlling a timing at which the set sound processing is executed, based on the reference timing, the set beat count information, and the performance signal. Here, executing the sound processing includes at least one of starting the sound processing and ending the sound processing. The timing at which the sound processing is executed means a timing at which the sound processing is started or a timing at which the sound processing is ended.

The control part 51 performs predetermined signal processing for imparting the set sound processing to the input performance signal based on the control signal. The control part 51 outputs the performance signal (sound signal) subjected to predetermined signal processing to a driving device for driving the vibration excitor 30.

The driving device generates the drive signal for driving the vibration excitor 30 based on the obtained performance signal, and outputs the drive signal to the main body 31 of the vibration excitor 30. The main body 31 vibrates the back board 15 in accordance with the drive signal. As a result, a desired sound effect can be imparted to the performance sound corresponding to the performance operation on the guitar 1 at a desired timing based on the beat count information and the play speed.

### [Modification 7]

Unlike the embodiment described above, the control part 51 may control a timing at which the drive signal generated based on the sound signal input from the outside is output to the vibration exciter 30. For example, it is conceivable to reproduce a sound signal output from an external sound source by the guitar 1. In this case, the sound signal output from the outside is supplied to a driving device for driving the vibration excitor 30, and the driving device generates a driving signal based on the obtained sound signal and outputs the driving signal to the main body 31 of the vibration excitor 30. The user can set a timing at which the sound signal is reproduced by the guitar 1 via the operation unit 23. For example, in this case, the control part 51 may generate a control signal for controlling a timing of outputting the drive signal from the driving device to the vibration exciter 30 based on a reference timing and a timing set by the user. The control part 51 outputs the generated control signal to the driving device. The driving device outputs the drive signal generated based on the sound signal to the main body 31 of the vibration exciter 30 at a timing based on the obtained control signal.

What is claimed is:

1. A control method for a musical instrument, the method comprising:
calculating a play speed of the musical instrument based on performance information corresponding to a performance operation of the musical instrument;
receiving beat count information for identifying a number of beats; and
generating control information for controlling a timing of executing a process associated with a loop based on the beat count information and the play speed.

2. The control method according to claim 1, wherein executing the process associated with the loop includes starting or ending the process associated with the loop.

3. The control method according to claim 1, further comprising receiving an instruction for determining a reference timing, wherein
the timing of executing the process associated with the loop is determined based on the reference timing and a time determined based on the beat count information and the play speed.

4. The control method according to claim 1, wherein the beat count information is preset and includes at least one of beat information identifying a beat or information indicating a desired number of measures.

5. The control method according to claim 1, wherein the control information includes information for specifying at least one of a start or an end of recording of a performance sound corresponding to the performance operation.

6. The control method according to claim 1, wherein the control information includes information to start reproduction of a recorded performance sound.

7. A control device for a musical instrument, the control device comprising:
a memory storing a program; and
a processor that executes the program to:
calculate a play speed of the musical instrument based on performance information corresponding to a performance operation of the musical instrument;
receive beat count information for identifying a number of beats; and
generate control information for controlling a timing of executing a process associated with a loop based on the beat count information and the play speed.

8. The control device according to claim 7, wherein executing the process associated with the loop includes starting or ending the process associated with the loop.

9. The control device according to claim 7, wherein
the processor executes the program to receive an instruction for determining a reference timing, and
the timing of executing the process associated with the loop is determined based on the reference timing and a time determined based on the beat count information and the play speed.

10. The control device according to claim 7, wherein the beat count information is preset and includes at least one of beat information identifying a beat or information indicating a desired number of measures.

11. The control device according to claim 7, wherein the control information includes information for specifying at least one of a start or an end of recording of a performance sound corresponding to the performance operation.

12. The control device according to claim 7, wherein the control information includes information to start reproduction of a recorded performance sound.

13. A music instrument comprising:
the control device according to claim 7; and
an operator for receiving the performance operation.

14. The music instrument according to claim 13, wherein:
the operator includes a string vibrated by the performance operation, and the music instrument further comprise:
a soundboard to which vibration of the string is transmitted; and
a vibration exciter attached to the soundboard, the vibration exciter vibrating the soundboard based on a drive signal supplied thereto,
the drive signal corresponds to a sound generated by the process associated with the loop performed based on the control information.

15. A music instrument comprising:
a string;
a soundboard that transmits vibration of the string;
a detector attached to the soundboard to detect an input of an instruction of a user; and
a processor configured to execute a predetermined process at a timing determined based on a timing at which the instruction is received and a set delay time.

16. The music instrument according to claim 15, the predetermined process is a process associated with a loop.
